(19) United States
(12) Patent Application Publication
(10) Pub. No.: US 2026/0075695 A1
(43) Pub. Date: Mar. 12, 2026

(54) LASER SYSTEM AND METHOD FOR PROVIDING WORKING LASER PULSES FOR INTERACTION WITH TARGETS AND ASSOCIATED COMPUTER PROGRAM PRODUCT

(71) Applicant: TRUMPF Laser SE, Schramberg (DE)

(72) Inventors: Jonathan Brons, Aichhalden (DE); Stephan Haefner, Donaueschingen (DE); Dirk Sutter, Rottweil (DE)

(21) Appl. No.: 19/393,622

(22) Filed: Nov. 19, 2025

Related U.S. Application Data
(63) Continuation of application No. PCT/EP2024/064613, filed on May 28, 2024.

(30) Foreign Application Priority Data
May 30, 2023 (DE) 10 2023 114 117.1

(51) Int. Cl. H05G 2/00

(52) U.S. Cl. CPC H05G 2/0084

(57) ABSTRACT

A laser system for providing working laser pulses for interaction with targets, which pass periodically one after another through a destination area, includes a laser pulse emitting device for emitting the working laser pulses. At least one working laser pulse of the working laser pulses is assigned to each respective target of the targets. The laser system further includes a control device for controlling the laser pulse emitting device. The control device is configured to set a respective emission time of each respective working laser pulse such that, as an ON working laser pulse, the respective working laser pulse strikes a respective target in the destination area in order to interact with the respective target, or as an OFF working laser pulse, temporally misses the respective target in the destination area in order not to interact with the respective target.

### CROSS REFERENCE TO RELATED APPLICATIONS

This application is a continuation of International Application No. PCT/EP2024/064613 (WO 2024/246047 A1), filed on May 28, 2024, and claims benefit to German Patent Application No. DE 10 2023 114 117.1, filed on May 30, 2023. The aforementioned applications are hereby incorporated by reference herein.

### FIELD

Embodiments of the present invention relate to a laser system and to a method for providing working laser pulses for interaction with targets which pass periodically one after the other, or with the exception of a period error pass periodically one after the other through a destination area, as well as to an associated computer program product.

### BACKGROUND

US 2022/0317576 A1 describes a laser system for generating secondary radiation in which laser pulses strike a stream of virtually evenly spaced targets to generate the secondary radiation. Based on the detected target position and trajectory, a trigger signal is generated that requests a laser pulse so as to interact with the target.

A method is known from DE 10 2014 017 568 A1 for generating amplified output laser pulses at individually specified times, these being achieved by free triggering using a pulse picker. For this purpose, a high-power ps laser is used, which consists of a mode-locked seeder with a pulse repetition rate of some 10 MHz, a pulse picker, an amplifier, a modulator and optionally a frequency conversion unit. The pulse picker consists of a modulator and a driver, with which at least three levels can be set according to a specification for different pulse amplitudes downstream of the pulse picker. If the time interval between two requested pulses is greater than the reciprocal of a nominal pulse repetition rate, the driver switches to an intermediate level, such that the pulse picker allows through pulses of a predefined, low amplitude in order to condition the gain of the laser medium for constant laser parameters.

Finally, DE 10 2017 210 272 B3 also discloses a Pulse-on-Demand (POD) laser system for generating amplified laser pulses at individually specified times. If, for example, laser pulses with different pulse energies are requested, a corresponding energy reduction occurs through timed partial outcoupling as a function of the known pulse intervals thereof relative to the respectively immediately preceding input laser pulse or inserted preceding sacrificial laser pulse.

### SUMMARY

Embodiments of the present invention provide a laser system for providing working laser pulses for interaction with targets, which pass periodically one after another through a destination area. The laser system includes a laser pulse emitting device for emitting the working laser pulses. At least one working laser pulse of the working laser pulses is assigned to each respective target of the targets. The laser system further includes a control device for controlling the laser pulse emitting device. The control device is configured to set a respective emission time of each respective working laser pulse such that, as an ON working laser pulse, the respective working laser pulse strikes a respective target in the destination area in order to interact with the respective target, or as an OFF working laser pulse, temporally misses the respective target in the destination area in order not to interact with the respective target.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an exemplary embodiment of a laser system for providing working laser pulses for interaction with periodically emitted targets; and

FIG. 2a, FIG. 2b, FIG. 2c, and FIG. 2d show an exemplary temporal representation of the energy control over time of the laser system according to embodiments of the invention when switching between working laser pulses that strike the targets and working laser pulses that temporally miss the targets.

### DETAILED DESCRIPTION

Embodiments of the invention provide a laser system and a method that can enable a working laser pulse intended for interaction with the target to be generated and at the same time enables controllability with regard to interaction of the working laser pulses with the target.

According to embodiments of the invention, a laser system for providing working laser pulses for interaction with targets which pass periodically one after the other, or with the exception of a period error pass periodically one after the other through a destination area, comprising a laser pulse emitting device for emitting working laser pulses, wherein at least one working laser pulse is assigned to each target, and comprising a control device which controls the laser pulse emitting device and is configured to set the emission time of a working laser pulse such that, as an ON working pulse, the working laser pulse strikes a target in the destination area in order to interact with the target or, as an OFF working laser pulse, temporally misses the target in the destination area in order not to interact with the target.

According to embodiments of the invention, the ON working laser pulse strikes the target positioned in the destination area, while the OFF working laser pulse temporally misses the target in the destination area. The working laser pulses can be driven by an external control signal in accordance with a Pulse-on-Demand (POD) scheme. The division into working and intermediate laser pulses means that less laser power has to be held in reserve compared to the prior art. The targets pass through the destination area in the form of a target stream with low temporal jitter.

The pulse energy of the ON working laser pulses preferably deviates from a pulse energy mean value by less than 3% and in particular by less than 1%, such that the ON working laser pulses have the same or virtually the same pulse energy for interaction with the targets.

In a preferred embodiment of the invention, the laser pulse emitting device comprises a laser beam source driven by the control device for generating input laser pulses (seed laser pulses) and an optical amplifier for amplifying input laser pulses into the working laser pulses and, if required, for amplifying further input laser pulses into intermediate laser pulses present between two working laser pulses. After amplifying an ON working laser pulse to a specified pulse energy, the optical amplifier requires a gain-related minimum time period to provide the same specified pulse energy for an immediately following ON working pulse. This gain-related minimum time period is required by the inversion structure required for amplification in the optical amplifier. The minimum possible period of the targets is preferably equal to or maximally greater than the gain-related minimum time period. The control device is in particular also configured to set the emission times and/or the pulse energy of the input laser pulses underlying the OFF working laser pulses and the intermediate laser pulses and thereby the energy stored in the optical amplifier such that the ON working laser pulses in each case have the same specified pulse energy.

To stabilize the pulse energy of the striking working laser pulses, the extractable energy of the amplifier system can be adjusted by additional, internally switched intermediate laser pulses (Pulse-on-Demand). The seed energy of the intermediate laser pulses can be selected to be ever larger as the pulse interval between two working laser pulses increases. In order to dissipate as little energy as possible, the seed energy for the working laser pulses to be triggered can also be reduced as the pulse interval between two working laser pulses becomes smaller. By triggering working and intermediate laser pulses with in each case separate energy compensation schemes, a specified energy stability can be ensured with respect to external reference events (targets) that repeat with an error-prone period. The external control signal requests laser pulses relative to the reference events and controls whether a laser pulse is to be triggered before, at the same time as, or after a respectively associated reference event.

Preferably, in the event that a current ON working laser pulse immediately follows an ON working laser pulse, the control device is configured to drive the laser beam source to emit the input laser pulse underlying the current ON working laser pulse and, if the time interval between these two working laser pulses is greater than the gain-related minimum time period, to emit a further input laser pulse, amplified in the optical amplifier into an intermediate laser pulse, between these two working laser pulses and to set the emission time and pulse energy thereof and thereby the energy stored in the optical amplifier for the current ON working laser pulse such that the current ON working laser pulse has the specified pulse energy.

Preferably, in the event that a current OFF working laser pulse immediately follows an ON working laser pulse, the control device is configured to drive the laser beam source to emit the input laser pulse underlying the current OFF working laser pulse, wherein the time interval between the current OFF working laser pulse and the ON working laser pulse is in particular smaller than the gain-related minimum time period. In this case, the control device can advantageously be configured to set the energy of the current OFF working laser pulse via the energy of the underlying input laser pulse in such a way that an ON or OFF working laser pulse immediately following the current OFF working laser pulse can again reach the specified pulse energy after the gain-related minimum time period.

Preferably, in the event that a current OFF working laser pulse immediately follows an OFF working laser pulse, the control device is configured to drive the laser beam source to emit the input laser pulse underlying the current OFF working pulse and, if the time interval between these two working laser pulses is greater than the gain-related minimum time period, to emit a further input laser pulse, amplified in the optical amplifier into an intermediate laser pulse, between these two working laser pulses.

Preferably, in the event that a current ON working laser pulse immediately follows an OFF working laser pulse, the control device is configured to drive the laser beam source to emit the input laser pulse underlying the current ON working pulse and, if the time interval between these two working laser pulses is greater than the gain-related minimum time period, to emit a further input laser pulse, amplified in the optical amplifier into an intermediate laser pulse, between these two working laser pulses and to set the emission time and pulse energy thereof and thereby the energy stored in the optical amplifier for the current ON working laser pulse such that the current ON working laser pulse has the specified pulse energy.

The pulse energy of the OFF working laser pulses and/or the intermediate laser pulses is advantageously at most as high as the specified pulse energy of the ON working laser pulses.

Preferably, an OFF working laser pulse reaches the destination area at least a minimum time interval earlier than the associated target in order to ensure that no interaction takes place between the OFF working laser pulse and the target. This minimum time interval is greater than the minimum possible period of the targets.

In particular, the control device is configured to emit an intermediate laser pulse at least a second minimum time period before an immediately following working laser pulse.

Preferably, the laser beam source is configured to provide the input laser pulses with a constant pulse energy.

In order to be able to individually set the pulse energy of the input pulses and thus the pulse energy of the working and intermediate laser pulses, an optical modulator driven by the control device is preferably arranged upstream of the optical amplifier, said modulator modulating the input laser pulse energy accordingly, e.g., by modulating the amplitude or trimming the pulse edges. The optical modulator may, for example, be an AOM (acousto-optic modulator) or an EOM (electro-optic modulator). The system may also include an amplifier chain or a frequency conversion downstream of the optical amplifier, and the device for setting the pulse energy may be arranged upstream of or indeed between the amplifiers.

Particularly preferably, the laser system comprises a pulse picker (e.g., AOM or EOM) arranged between the optical amplifier and the destination area and driven by the control device to pick out the intermediate laser pulses from the further beam path of the working laser pulses. This ensures that the intermediate laser pulses cannot accidentally strike a target.

Preferably, the picked-out intermediate laser pulses are eliminated internally, e.g., by means of a beam trap. Alternatively, the input laser pulses underlying the intermediate laser pulses can have a different wavelength. After being amplified in a broadband optical amplifier, the intermediate laser pulses are picked out using a pulse picker embodied as a spectral filter. An intermediate laser pulse with suitable polarization could also be triggered which is then picked out downstream of the optical amplifier using a pulse picker embodied as a polarization filter.

Further preferably, the control device is configured to emit at least one intermediate pulse if the time interval between the next working laser pulse to be emitted and the previous working laser pulse is greater than a specified maximum duration, which is greater than the gain-related minimum time period and can, for example, be twice the minimum time period. In this case, the control device triggers an intermediate laser pulse, e.g., after the gain-related minimum time period, which has the energy of the ON working laser pulse and prevents too much energy from being stored in the optical amplifier. For longer time intervals between two working laser pulses, a plurality of intermediate laser pulses are accordingly inserted, in each case for example at intervals of the gain-related minimum time period, so that not too much energy is stored in the optical amplifier.

Preferably, each target is assigned a control signal from which the arrival time of the target in the destination area can be determined, and the control device is configured to emit an ON or an OFF working laser pulse based on the respective control signal.

In a further aspect, embodiments of the invention also relate to a method for providing working laser pulses for interaction with targets which pass periodically one after the other, or with the exception of a period error pass periodically one after the other through a destination area, comprising the following method steps:
emitting at least one working laser pulse for each target; and
setting an emission time for the at least one working laser pulse using a control device in such a way that the working laser pulse either, as an ON working laser pulse, strikes a target in the destination area in order to interact with the target or, as an OFF working laser pulse, temporally misses the target in the destination area so as not to interact with the target.

Preferably, the ON or OFF working laser pulses are emitted on the basis of control signals that are assigned in each case to the targets and from which the respective arrival time of the targets in the destination area can be determined.

Embodiments of the invention also relate to a control program product which has code means adapted for carrying out all the steps of the method according to embodiments of the invention when the program runs on a control device of the laser system according to embodiments of the invention.

Further advantages of the embodiments of the invention are revealed by the description and the drawings. Likewise, the features mentioned above and those yet to be explained further can be used in each case individually or together in any desired combinations.

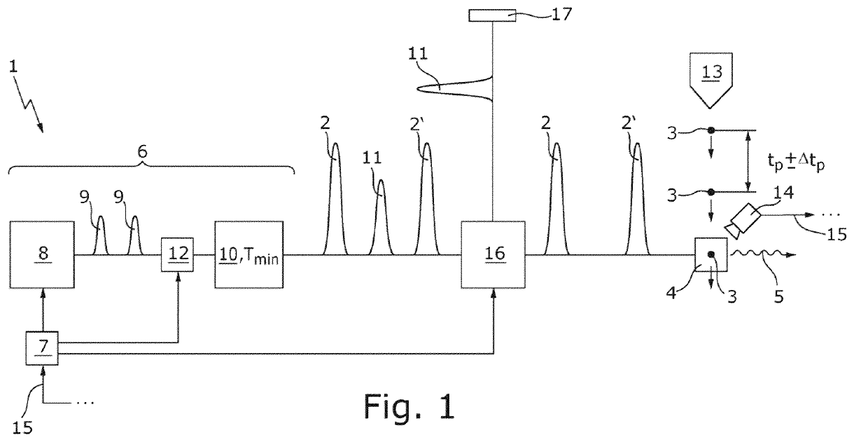

The laser system 1 shown in FIG. 1 serves to provide working laser pulses 2, 2′ for interaction with targets 3 which pass periodically with a period tₚ or periodically with the exception of a period error Δtₚ, i.e., in the form of a target stream with low temporal jitter, one after the other through a destination area 4.

Through interaction of the working laser pulses 2 with the targets 3 in the destination area 4, secondary radiation 5 (e.g., EUV radiation) can be generated. For example, the target material is or comprises tin.

The laser system 1 has a laser pulse emitting device 6 for generating the working laser pulses 2, 2′ and a control device 7 by means of which emission of the working laser pulses 2, 2′ by the laser pulse emitting device 6 can be triggered and/or controlled at specific times. For example, provision may be made for the laser pulse emitting device 6 to emit a working laser pulse 2, 2′ as a single laser pulse or in the form of a laser pulse packet (laser burst) when the control device 7 receives a corresponding control signal. This allows working laser pulses 2, 2′ with individual pulse energy to be specifically requested at given times, something which can be achieved, for example, using known Pulse-on-Demand concepts.

As shown in FIG. 1, the laser pulse emitting device 6 comprises, for example, a laser beam source 8 driven by the control device 7 for generating input laser pulses 9 with preferably constant pulse energy and an optical amplifier 10 for amplifying input laser pulses 9 into the working laser pulses 2, 2′ and, if required, for amplifying further input laser pulses 9 into intermediate laser pulses 11, which can be picked out using an optional pulse picker 16 from the further beam path of the working laser pulses 2, 2′ and therefore do not reach the destination area 4. The pulse picker 16 is arranged between the optical amplifier 10 and the destination area 4 and is driven by the control device 7 in order to deflect the intermediate laser pulses 11 from the beam path of the working laser pulses 2, 2′ and feed them, for example, to a beam trap 17. This ensures that the intermediate laser pulses 11 cannot accidentally strike a target 3. Preferably, the pulse picker 16 is an AOM or EOM.

If an input laser pulse 9 has been amplified into a working laser pulse 2, 2′ with a specified pulse energy Eₙₒₘ, the optical amplifier 10 requires a gain-related minimum time period Tₘᵢₙ for a new inversion structure in order to provide the same specified pulse energy Eₙₒₘ for an immediately following working pulse 2, 2′. The minimum possible period tₚ−Δtₚ of the target 3 is greater than or equal to the gain-related minimum time period Tₘᵢₙ. The input laser pulses 9 underlying the working and intermediate laser pulses 2, 2′, 11 can be either a single laser pulse or a laser pulse packet (laser burst).

The laser pulse emitting device 6 optionally has an optical modulator 12 arranged upstream of the optical amplifier 10 for individually setting the pulse energy of the input laser pulses 9 in order to set the pulse energy of the working and intermediate laser pulses 2, 2′, 11 accordingly. The optical modulator 12 is driven by the control device 7 in order to set the in each case desired pulse energy of the input laser pulses 9, e.g., by modulating the amplitude or trimming the pulse edges, and may, for example, take the form of an AOM or EOM.

To feed the targets 3 into the destination area 4, the laser system 1 can have a target emitting device 13 by means of which the targets 3 are emitted in such a way that they periodically pass one after the other through the destination area 4 with the period tₚ±Δtₚ. For example, the targets 3 may be emitted by the target emitting device 13 in the form of individual droplets and in the direction of gravity, i.e., downward in FIG. 1, and pass through the destination area 4 from top to bottom. A target detection device (e.g., a camera) 14 may additionally be arranged downstream of the target emitting device 13, said target detection device detecting an emitted target 3 and in particular also the target geometry thereof, for example using image recognition, at the latest in the destination area 4 and delivering a corresponding external control signal 15 to the control device 7. The control signals can be used to determine the respective arrival time of the targets 3 in the destination area 4. Based on the control signal 15, the control device 7 then controls the laser pulse emitting device 6 to emit a working laser pulse 2, 2′. However, if the time interval between the working laser pulse 2, 2′ to be emitted and the previous working laser pulse 2, 2′ is greater than a specified maximum duration, which is greater than the gain-related minimum time period Tₘᵢₙ and amounts, for example to 2*Tₘᵢₙ, the control device 7 preferably, e.g., after the gain-related minimum time period Tₘᵢₙ, triggers an intermediate laser pulse 11, which has the energy of the ON working laser pulse 2 and prevents too much energy from being stored in the optical amplifier 10. For longer time intervals between two working laser pulses of n*Tₘᵢₙ (n>=2), n−1 additional intermediate pulses 11 are inserted at intervals of Tₘᵢₙ so that not too much energy is stored in the optical amplifier 10.

For technical details concerning the incoupling of targets 3 into the destination area 4 for generating secondary radiation 5, reference is made to the scientific publication “Light sources for high-volume manufacturing EUV lithography: technology, performance, and power scaling”, I. Fomenkov et al., Advanced Optical Technologies 6(3):173-186, DOI: 10.1515/aot-2017-0029.

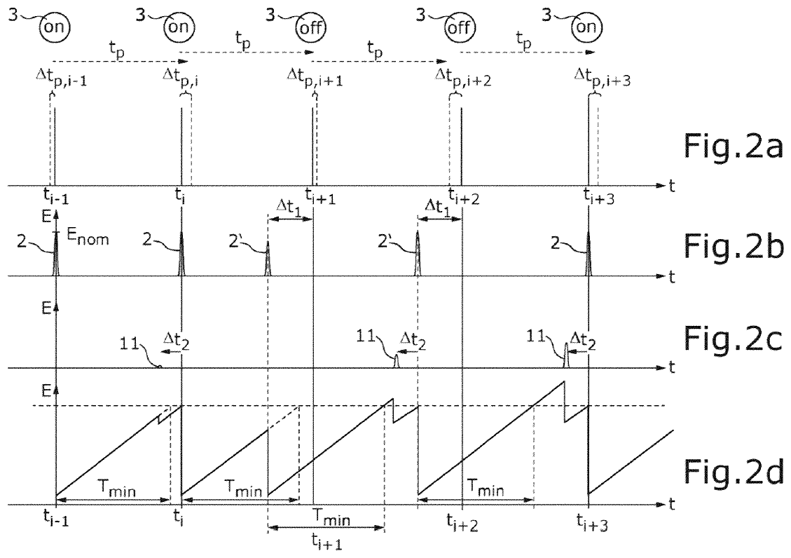

FIGS. 2a-2d show an exemplary representation of energy control over time of the laser system 1 when switching between working laser pulses 2 that strike the targets 3 in the destination area 4 and working laser pulses 2′ that temporally miss the targets 3 in the destination area 4.

FIG. 2a shows the targets 3 output by the target emitting device 13, these being positioned in the destination area 4 at the times tᵢ₋₁, tᵢ, tᵢ₊₁, tᵢ₊₂ and tᵢ₊₃. The targets 3 that are used to generate secondary radiation 5 are referred to as ON targets and the targets 3 that are not used to generate secondary radiation 5 (e.g., because of too great a period error, non-optimal target geometry or so as to modulate the power of the secondary radiation source or to omit working pulses) are referred to as OFF targets.

As shown in FIG. 2b, each target 3 is assigned a working pulse 2, 2′. The working pulses that strike an assigned ON target 3 in the destination area 4 in order to interact with the ON target 3 are referred to as ON working laser pulses 2 and the working laser pulses that temporally miss an assigned OFF target 3 in the destination area 4 in order not to interact with the OFF target 3 are referred to as OFF working laser pulses 2′. The ON working pulses 2 are requested by the control device 7 at the times tᵢ₋₁, tᵢ and tᵢ₊₃ in order to interact with the ON targets 3 in the destination area 4, and in each case have the same specified pulse energy Eₙₒₘ. The pulse energy of the ON working laser pulses 2 preferably deviates from a specified pulse energy mean value by less than 3% and in particular by less than 1%. The OFF working pulses 2′, on the other hand, are requested earlier by the control device 7 by at least a minimum time interval Δt₁ than the associated OFF targets 3 are positioned in the destination area 4, i.e., in this case at the times tᵢ₊₁−Δt₁, tᵢ₊₂−Δt₁, and with an individually settable pulse energy which, however, should be no greater than the specified pulse energy Eₙₒₘ of the ON working pulses 2. The minimum time interval Δt₁ is selected such that no interaction takes place between the OFF working laser pulse 2′ and the OFF target 3.

As shown in FIG. 2c, the control device 7 can, if required, in each case request an intermediate laser pulse 11 at least a second minimum time interval Δt₂ before an ON or OFF working laser pulse 2, 2′, i.e., in this case at the times tᵢ−Δt₂, tᵢ₊₂−Δt₁−Δt₂ and tᵢ₊₃−Δt₂, and with an individually settable pulse energy which, however, should be not greater than the specified pulse energy Eₙₒₘ of the ON working pulses 2. The time and pulse energy of the OFF working laser pulses 2′ and the intermediate laser pulses 11 are selected such that, on the one hand, the energy E stored in the optical amplifier 10 for the ON working laser pulses 2 is always the same in order to amplify the ON working laser pulses 2 in the optical amplifier 10 in each case to the same specified pulse energy Eₙₒₘ, and on the other hand to have to keep as little power in reserve as possible in the optical amplifier 10.

FIG. 2d shows the associated time profile of the energy E stored in the optical amplifier 10. In this case, the control device 7, as described below, sets the emission times and/or the pulse energy of the input laser pulses 9 underlying the OFF working laser pulses 2′ and the intermediate laser pulses 11 and thereby the energy E stored in the optical amplifier 10 such that the ON working laser pulses 2 in each case have the same specified pulse energy Eₙₒₘ.
1. If a current ON working laser pulse 2 (here at time tᵢ) immediately follows an ON working laser pulse 2 (here at time tᵢ₋₁):
   The control device 7 requests the current ON working laser pulse 2 with pulse energy Eₙₒₘ at time tᵢ of the ON target 3 and if, as in the present case, the time interval between the two ON working laser pulses 2 is greater than the gain-free minimum time period Tₘᵢₙ, i.e., tᵢ−tᵢ₋₁>Tₘᵢₙ, an intermediate laser pulse 11 between these two working laser pulses, here at time tᵢ−Δt₂. The request time and pulse energy of the intermediate laser pulse 11 are set by the control device 7 such that the energy E stored in the optical amplifier 10, which decreases due to the amplification of the intermediate laser pulse 11, will have risen again to such an extent at the time tᵢ that the current ON working laser pulse 2 is amplified to the specified pulse energy Eₙₒₘ.
   If the time interval between the two ON working laser pulses 2 is equal to the gain-free minimum time period Tₘᵢₙ, i.e., tᵢ−tᵢ₋₁=Tₘᵢₙ, no intermediate laser pulse 11 needs to be requested by the control device 7. A time interval between two ON working laser pulses 2 smaller than the gain-free minimum time period Tₘᵢₙ, i.e, tᵢ−tᵢ₋₁<Tₘᵢₙ, on the other hand, is inadmissible and is not permitted by the control device 7 or is evaluated as an OFF working laser pulse, and the pulse energy is set as a function of the interval from the minimum time period Tₘᵢₙ, as described below under 2.
2. If a current OFF working laser pulse 2′ (here at time tᵢ₊₁−Δt₁) immediately follows an ON working laser pulse 2 (here at time tᵢ):
   The control device 7 requests the current OFF working laser pulse 2′ at time tᵢ₊₁−Δt₁. The time interval between the current OFF working laser pulse 2′ and the previous ON working laser pulse 2, i.e., (tᵢ₊₁−Δt₁)−tᵢ, is selected to be no greater than the gain-free minimum time period Tₘᵢₙ, such that the current OFF working laser pulse 2′ is amplified at most to the specified pulse energy Eₙₒₘ. The request time and pulse energy of the current OFF working laser pulse 2′ are preferably set by the control device 7 such that the energy E stored in the optical amplifier 10, which decreases due to the amplification of the current OFF working laser pulse 2′, will have risen again after the gain-free minimum time period Tₘᵢₙ to such an extent that an immediately following ON or OFF working laser pulse 2, 2′ is amplified to the specified pulse energy Eₙₒₘ. As shown, the pulse energy of the current OFF working laser pulse 2′does not exceed the specified pulse energy Eₙₒₘ of the ON working laser pulses 2.
3. If a current OFF working laser pulse 2′ (here at time tᵢ₊₂−Δt₁) immediately follows an OFF working laser pulse 2′ (here at time tᵢ₊₁−Δt₁):
   The control device 7 requests the current OFF working laser pulse 2′ e.g., with pulse energy Eₙₒₘ at time tᵢ₊₂−Δt₁ and if, as in the present case, the time interval between these two OFF working laser pulses is greater than the gain-free minimum time period Tₘᵢₙ, i.e., (tᵢ₊₂−Δt₁)−(tᵢ₊₁−Δt₁)>Tₘᵢₙ, an intermediate laser pulse 11 between these two working laser pulses, here at time (tᵢ₊₂−Δt₁)−Δt₂. The request time and pulse energy of the intermediate laser pulse 11 are set by the control device 7 such that the energy E stored in the optical amplifier 10, which decreases due to the amplification of the intermediate laser pulse 11, will have risen again at the time tᵢ₊₂−Δt₁ to such an extent that the current OFF working laser pulse 2′ is amplified to the specified pulse energy Eₙₒₘ or indeed to a lower pulse energy.
   As shown, the stored energy E before amplification of the intermediate laser pulse 11 may rise to an energy level which may be higher than when the ON working laser pulses 2 are amplified to the specified pulse energy Eₙₒₘ. However, the pulse energy of the intermediate pulse 11 does not exceed the specified pulse energy Eₙₒₘ of the ON working laser pulses 2.
4. If a current ON working laser pulse 2 (here at time tᵢ₊₃) immediately follows an OFF working laser pulse 2′ (here at time tᵢ₊₂−Δt₁):
   The control device 7 requests the current ON working laser pulse 2 with pulse energy Eₙₒₘ at time tᵢ₊₃ and if, as in the present case, the time interval between these two working laser pulses is greater than the gain-free minimum time period Tₘᵢₙ, i.e., (tᵢ₊₃)−(tᵢ₊₂−Δt₁)>Tₘᵢₙ, an intermediate laser pulse 11. The request time and pulse energy of the intermediate laser pulse 11 are set by the control device 7 such that the energy E stored in the optical amplifier 10, which decreases due to the amplification of the intermediate laser pulse 11, will have risen again at the time tᵢ₊₃ to such an extent that the current ON working laser pulse 2 is amplified to the specified pulse energy Eₙₒₘ. As shown, the stored energy E before amplification of the intermediate laser pulse 11 can rise to an energy level which may be higher than when the working laser pulses are amplified to the specified pulse energy Eₙₒₘ. However, the pulse energy of the intermediate pulse 11 does not exceed the specified pulse energy of the ON working laser pulses 2.

For the case not shown in FIG. 2, where the time interval between a working laser pulse 2, 2′ to be emitted and the previous working laser pulse 2, 2′ is greater than a specified maximum duration, which is greater than the gain-related minimum time period Tₘᵢₙ and amounts, for example, to 2*Tₘᵢₙ, an intermediate laser pulse 11 is triggered by the control device 7, e.g., after the gain-related minimum time period Tₘᵢₙ, that has the energy of the ON working laser pulse 2 and prevents too much energy from being stored in the optical amplifier 10. For longer time intervals between two working laser pulses of n*Tₘᵢₙ (n>=2), n−1 additional intermediate pulses 11 are in each case inserted at intervals of Tₘᵢₙ so that not too much energy is stored in the optical amplifier 10.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser system for providing working laser pulses for interaction with targets which pass periodically one after another through a destination area, the laser system comprising:
a laser pulse emitting device for emitting the working laser pulses, wherein at least one working laser pulse of the working laser pulses is assigned to each respective target of the targets,
a control device for controlling the laser pulse emitting device, wherein the control device is configured to set a respective emission time of each respective working laser pulse such that, as an ON working laser pulse, the respective working laser pulse strikes a respective target in the destination area in order to interact with the respective target, or as an OFF working laser pulse, temporally misses the respective target in the destination area in order not to interact with the respective target.

2. The laser system as claimed in claim 1, wherein a pulse energy of the ON working laser pulse deviates from a pulse energy mean value by less than 3%.

3. The laser system as claimed in claim 1, wherein the laser pulse emitting device comprises:
a laser beam source driven by the control device for generating input laser pulses and further input laser pulses, and
an optical amplifier for amplifying the input laser pulses into the working laser pulses and for amplifying the further input laser pulses into intermediate laser pulses present between two working laser pulses, wherein the optical amplifier, after amplification of a respective ON working laser pulse to a specified pulse energy, requires a gain-related minimum time period in order to provide the same specified pulse energy for an immediately following ON working laser pulse, and wherein the control device is configured to set the emission times and/or a pulse energy of the input laser pulses underlying the OFF working laser pulses and the intermediate laser pulses and thereby to set an energy stored in the optical amplifier such that the ON working laser pulses have the same specified pulse energy.

4. The laser system as claimed in claim 3, wherein, for a current ON working laser pulse immediately follows an ON working laser pulse, the control device is configured to drive the laser beam source to emit the input laser pulse underlying the current ON working laser pulse, and for a time interval between these two working laser pulses that is greater than the gain-related minimum time period, to emit a further input laser pulse, amplified in the optical amplifier into an intermediate laser pulse between these two working laser pulses and to set the emission time and the pulse energy thereof and thereby the energy stored in the optical amplifier for the current ON working laser pulse such that the current ON working laser pulse has the specified pulse energy.

5. The laser system as claimed in claim 3, wherein, for a current OFF working laser pulse immediately follows an ON working laser pulse, the control device is configured to drive the laser beam source to emit the input laser pulse underlying the current OFF working laser pulse, wherein the time interval between the current OFF working laser pulse and the ON working laser pulse is smaller than the gain-related minimum time period.

6. The laser system as claimed in claim 5, wherein the control device is configured to set the energy of the current OFF working laser pulse via the energy of the underlying input laser pulse in such a way that an ON or OFF working laser pulse immediately following the current OFF working laser pulse again reaches the specified pulse energy after the gain-related minimum time period.

7. The laser system as claimed in claim 3, wherein, for a current OFF working laser pulse immediately follows an OFF working laser pulse, the control device is configured to drive the laser beam source to emit the input laser pulse underlying the current OFF working pulse and, for the time interval between these two working laser pulses that is greater than the gain-related minimum time period, to emit a further input laser pulse, amplified in the optical amplifier into an intermediate laser pulse, between these two working laser pulses.

8. The laser system as claimed in claim 3, wherein, for a current ON working laser pulse immediately follows an OFF working laser pulse, the control device is configured to drive the laser beam source to emit the input laser pulse underlying the current ON working pulse and, for the time interval between these two working laser pulses that is greater than the gain-related minimum time period, to emit a further input laser pulse, amplified in the optical amplifier into an intermediate laser pulse, between these two working laser pulses and to set the emission time and pulse energy thereof and thereby the energy stored in the optical amplifier for the current ON working laser pulse such that the current ON working laser pulse has the specified pulse energy.

9. The laser system as claimed in claim 3, wherein the pulse energy of the OFF working laser pulses and/or the intermediate laser pulses is at most as high as the specified pulse energy of the ON working laser pulses.

10. The laser system as claimed in claim 3, wherein an OFF working laser pulse reaches the destination area at least a minimum time interval earlier than the associated target in order to ensure that no interaction takes place between the OFF working laser pulse and the target.

11. The laser system as claimed in claim 3, wherein the control device is configured to emit an intermediate laser pulse at least a second minimum time period before an immediately following working laser pulse.

12. The laser system as claimed in claim 3, wherein the laser beam source is configured to provide the input laser pulses with a constant pulse energy.

13. The laser system as claimed in claim 3, wherein the laser pulse emitting device further comprises an optical modulator driven by the control device and arranged upstream of the optical amplifier in order to set the pulse energy of the input laser pulses and thereby the pulse energy of the OFF working laser pulses and the intermediate laser pulses.

14. The laser system as claimed in claim 3, further comprising a pulse picker arranged between the optical amplifier and the destination area, wherein the pulse picker is configured to pick out the intermediate laser pulses from a further beam path of the working laser pulses.

15. The laser system as claimed in claim 3, wherein the control device is configured to emit at least one intermediate pulse if the time interval between the next working laser pulse to be emitted and the previous working laser pulse is greater than a specified maximum duration which is greater than the gain-related minimum time period.

16. The laser system as claimed in claim 1, wherein each target is assigned a respective control signal, and the control device is configured to emit an ON working laser pulse or an OFF working laser pulse based on the respective control signal.

17. A method for providing working laser pulses for interaction with targets which pass periodically one after another through a destination area, the method comprising:
emitting at least one working laser pulse for each target; and
setting an emission time for the at least one working laser pulse using a control device in such a way that the working laser pulse either, as an ON working laser pulse, strikes a target in the destination area in order to interact with the target or, as an OFF working laser pulse, temporally misses the target in the destination area so as not to interact with the target.

18. The method as claimed in claim 17, wherein the ON working laser pulses and the OFF working laser pulses are emitted based on control signals assigned to the targets.

19. A non-transitory computer-readable medium having program steps stored thereon, the program steps, when executed by a computer processor, causing performance of the method as claimed in claim 17.
